(19) United States
(12) Patent Application Publication
(10) Pub. No.: US 2009/0036302 A1
(43) Pub. Date: Feb. 5, 2009

(54) PROCESS FOR PRODUCING NANOPOROUS CARBIDE DERIVED CARBON WITH LARGE SPECIFIC SURFACE AREA

(76) Inventors: Yury Gogotsi, Warminster, PA (US); Gleb Yushin, Atlanta, GA (US); Elizabeth Nola Hoffman, Aiken, SC (US); Michel M. Barsoum, Moorestown, NJ (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/094,501

(22) PCT Filed: Nov. 21, 2006
(86) PCT No.: PCT/US06/45154

§ 371 Date: Oct. 14, 2008

Related U.S. Application Data
(60) Provisional application No. 60/739,910, filed on Nov. 23, 2005.

(51) Int. Cl. B01J 20/20; C01B 31/02; B32B 5/18

(52) U.S. Cl. 502/402; 423/445 B; 428/141; 502/418

(57) ABSTRACT

Processes for the synthesis of high specific surface area nanoporous carbons by reacting select carbides with one or more halogens to produce compositions comprising carbon and halogens and contacting the reacted carbides with a species capable of removing the halogen are provided. Methods for removing halogen impurities from carbon compositions having pores and for modifying the surface terminations of carbon compositions having pores are also provided.

### CROSS REFERENCE TO RELATED APPLICATIONS

This application claims the benefit of U.S. Provisional Application No. 60/739,910, filed Nov. 23, 2005, the entirety of which is incorporated by reference herein.

### FIELD OF THE INVENTION

The present invention pertains to the field of material science, and pertains especially to porous materials.

### BACKGROUND OF THE INVENTION

Materials containing large specific surface areas are advantageous for adsorption processes such as gas separation, purification, and storage. Materials used commercially as sorbents include zeolites, silica gel, polymeric resins, and carbon.

Porous carbons are the oldest adsorbents known. The use of porous carbon in Egypt was described as early as 1550 BC. D. O. Cooney, Activated Charcoal: Antidotal and other Medical Uses, 1980, New York: Dekker. The first industrial production of activated carbons (“ACs”) in the United States started in 1913. F. S. Baker, C. E. Miller, and E. D. Repik, Kirk-Othmer Encyclopedia of Chemical Technology, v. 4. 1992, John Wiley: New York. p. 1015-1037. ACs can be prepared from a very wide selection of natural and synthetic precursors. The most common natural precursors include wood, nutshells, peat, lignite, coal, and petroleum coke. Activated carbon compendium: a collection of papers from the journal Carbon 1996-2000, ed. H. Marsh. 2001, Amsterdam, New York: Elsevier. More advanced ACs with better-developed porosity and more uniform pores are produced from synthetic polymers, such as polyacrylonitrile (PAN), polyvinylidene chloride (PVDC), polyvinyl chloride (PVC), and polyfurfuryl alcohol (PFA). Activated carbon compendium: a collection of papers from the journal Carbon 1996-2000, ed. H. Marsh. 2001, Amsterdam, New York: Elsevier, to mention a few. Activation processes are generally divided into two categories: thermal and chemical. Production of ACs by thermal (physical) activation involves carbonization of a precursor and gasification. Production of ACs by chemical activation generally involves the reaction of a precursor with a chemical reagent at elevated temperatures. Although the first industrial production of activated carbons started nearly a century ago, little control over the porosity has been achieved despite extensive studies and improvements in activation processes.

High surface area carbons have also been produced by extraction of metals from carbides. Such carbons are called carbide derived carbons (CDCs). A. Nikitin, et al, Nanostructured Carbide-Derived Carbon (CDC), in Encyclopedia of Nanoscience and Nanotechnology, v. 7, H. S. Nalwa, Editor. 2003, American Scientific Publishers: CA. p. 553-574; R. K. Dash, et al., Nanoporous Carbon Derived from Zirconium Carbide, Microporous and Mesoporous Materials, 2005 (in press); E. Hoffman, et al., Synthesis of Nanoporous Carbide-Derived Carbon by Chlorination of Titanium Aluminum Carbide, Chem. Mater., 2005.17: p. 2317-2322; R. K. Dash, et al., Microporous Carbon Derived from Boron Carbide. Microporous and Mesoporous Materials, 2004.72: p. 203-208; A. Nikitin et al., Nanostructured Carbide-Derived Carbon, in Encyclopedia of Nanoscience and Nanotechnology, v. 7, H. S. Nalwa, Editor. 2004, American Scientific Publishers: CA. p. 553-574.

Large specific surface areas are desirable for many applications of porous carbons, including gas storage, separation media, purification of gases and fluids, and electrochemical applications of porous carbons.

An additional consideration in the manufacture of porous carbons is the presence of unwanted species—such as halogens—on the surface of such porous carbons. Thus, there exists a need for a method wherein unwanted species are removed from the surface of the porous carbons and a method for altering halogen surface terminations of porous carbons.

### SUMMARY OF THE INVENTION

The present invention provides methods for producing high specific surface area (“SSA”) nanoporous carbons via chlorination of selected carbides or carbonitrides or by hydrogen annealing select porous carbons with limited SSA. In addition, the present invention provides methods for removing halogen impurities from porous compositions produced by reacting metal carbides with or more halogens and for changing the surface termination of porous carbon compositions.

Accordingly, one aspect of the present invention provides porous carbon compositions comprising a plurality of pores, wherein the carbon composition has a total specific surface area of between about 1500 and 5000 m²/g, as measured according to the Brunauer-Emmet-Teller method, and wherein the composition adsorbs one or more particles from a fluid.

In other aspects, the present invention provides methods for making a carbon composition having pores, comprising heating a carbon-containing inorganic precursor; reacting the inorganic precursor with one or more halogens to give rise to a porous composition comprising carbon and halogen; and, contacting the porous composition with a halogen-removing agent capable of removing the halogen to give rise to the carbon composition, wherein the carbon composition has a characteristic surface area of between about 1500 and 5000 m²/g, as measured according to the Brunauer-Emmet-Tellet method, and wherein the pores have a pore volume of from about 0.5 cc/g to about 4 cc/g

Also provided are methods of adsorbing an adsorbate from a fluid containing an adsorbate, comprising contacting the fluid with a carbon composition having pores, wherein the carbon composition comprises a plurality of pores, and wherein the carbon composition has a characteristic surface area of between about 1500 and 5000 m²/g, as measured according to the Brunauer-Emmet-Tellet method, and the pores of the carbon composition have a pore volume of from about 0.5 cc/g to about 4 cc/g.

The present invention also provides methods for removing halogen species present in a porous carbon composition, wherein the composition comprises a plurality of pores, and wherein the carbon composition has a total specific surface area of between about 1500 and 5000 m²/g, as measured according to the Brunauer-Emmet-Teller method, and the pores of the carbon composition have a pore volume of from about 0.5 cc/g to about 4 cc/g; and contacting the porous carbon composition with a halogen-removing agent.

In further aspects, the present invention provides methods for modifying surface termination in a porous carbon composition, wherein the composition comprises a plurality of pores, and wherein the carbon composition has a total specific surface area of between about 1500 and 5000 m²/g, as measured according to the Brunauer-Emmet-Teller method, and the pores of the carbon composition have a pore volume of from about 0.5 cc/g to about 4 cc/g; and contacting the porous carbon composition with a non-halogenated surface terminating agent.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1A depicts argon sorption isotherms performed at −196° C. for Ta₂AlC-CDC and Ti₂AlC-CDC showing the former is capable of adsorbing significantly larger Ar volumes;

FIG. 1B depicts non-local density functional theory (NLDFT) pore size distribution (PSD) of Ta₂AlC-CDC and Ti₂AlC-CDC calculated from the argon sorption isotherms in FIG. 1A; the distribution of porosity is similar between the two carbons, however, the pore volume for Ta₂AlC-CDC is larger at any given pore size compared to Ti₂AlC-CDC;

FIG. 2 depicts NLDFT pore size distribution of Ti₃SiC₂-CDC chlorinated at 600° C., followed by H₂ annealing at temperatures ranging from 400-1200° C.; the curves were calculated from Ar sorption isotherms measured at −196° C.; in general, as the H₂ annealing temperature decreases, the pore volume increases; the width of the pore size distribution does not vary significantly; and,

FIGS. 3A-3D depict the effect of NH₃ annealing on the porosity (FIGS. 3B, 3D) and purity (FIGS. 3A, 3C) of porous carbon produced by chlorinating titanium carbide powder at 600° C. and 800° C.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a ranges of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

Carbon compositions can comprise a plurality of pores, wherein the carbon composition has a total specific surface area of between about 1500 and 5000 m²/g, as measured according to the Brunauer-Emmet-Teller method, and wherein the composition adsorbs one or more particles from a fluid. The pores of the carbon composition have a pore volume from about 0.5 cc/g to about 4 cc/g.

Carbon compositions having pores are suitably synthesized by heating a carbon-containing inorganic precursor; reacting the inorganic precursor with one or more halogens to give rise to a porous composition comprising carbon and halogen; and, contacting the porous composition with a halogen-removing agent capable of removing the halogen to give rise to the carbon composition, wherein the carbon composition has a characteristic surface area of between about 1500 and 5000 m²/g, as measured according to the Brunauer-Emmet-Tellet method.

The carbon-containing inorganic precursor can suitably comprise carbide, wherein the carbide comprises ternary carbide or carbonitride. The ternary carbide can comprise a MAX-phase group layered carbide; the MAX phases comprise an early transition metal (referred to as “M”), an element from the A groups of the periodic table, usually IIIA and IVA (referred to as “A”), and a third element, referred to as “X,” which third element is either nitrogen or carbon (black). These three elements form composition Mₙ₊₁AXₙ, where n is either 1, 2 or 3.

The precursor can be heated convectively, conductively, radiatively, or any combination thereof. The heating may suitably occur in a tube furnace, a fluidized bed furnace, a packed bed furnace, or a rotary kiln reactor, and the like. The invention further comprises purging the furnace prior to the heating, wherein the purging is suitably performed with a flow of gas that is inert to carbon and performed so as to remove air from the furnace.

The heating occurs at a temperature of at least about 400° C., at least about 600° C., at least about 800° C., at least about 1000° C., or at least about 1200° C.

Suitable heating rates can be from about 3 to about 100° C./minute. Heating continues until the desired temperature is reached and stabilized. Other heating rates outside of this range are also envisioned as providing the composition described herein. Combinations of heating rates may also be suitable.

Reacting the inorganic precursor with one or more halogens is performed for a time such that substantially all of the metal present in the inorganic precursor is no longer present. Removal of substantially all the metal present in the precursor is defined such that material having substantially all metal removed behaves essentially identically to precursor having all metal removed.

The halogen reaction suitably occurs for from about 0.1 to about 3 hours, or for from about 3 to about 10 hours. Other reaction durations outside of this range are envisioned as being capable of producing the product described herein.

The flow of the halogen is removed, suitably by bubbling the halogen flow through a solution comprising sulfuric acid. The removal of the halogen can further include bubbling the halogen through a solution comprising a halogen-removing agent, which agent may suitably includes potassium hydroxide, sodium hydroxide, and the like.

The invention also suitably comprises a purification step. The purification step comprises condensing metal-halogen compounds produced in the course of the reaction.

The methods also include cooling the recovered porous composition following the purification step. Cooling can be convective, conductive, radiative, or any combination thereof. The cooling can be performed, for example, by flowing a gas inert to carbon and halogens over the composition, wherein the flowrate of the gas is suitable to avoid oxidation of the porous composition. Suitable flowrates can be from about 0.1 to about 20 sccm/g of porous composition. The cooling suitably occurs to achieve a final temperature of less than about 200° C.

The flow of the inert gas is removed, suitably by bubbling the gas through a solution comprising sulfuric acid. The removal of the inert gas further comprises bubbling the gas through solution comprising a halogen-removing agent, which agent may comprise potassium hydroxide, sodium hydroxide, and the like.

The contacting with the halogen-removing agent is performed in a furnace, as described elsewhere herein. It is contemplated that the furnace is purged, as described elsewhere herein,

The contacting comprises flowing the halogen-removing agent over the porous composition. Suitable agents include hydrogen or ammonia. The flowing is performed for a time such that substantially all of the halogen present in the composition is no longer present. Removal of substantially all of the halogen from the composition is defined such that porous composition having substantially all halogen removed behaves essentially identically to porous composition having all halogen removed. Suitable agent flowrates can be from about 0.1 to 100 sccm/g of porous composition.

The flowing is performed at a temperature of at least about 200° C., at least about 400° C., at least about 600° C., at least about 800° C., or at a temperature of at least about 1200° C.

The cooling of the carbon composition following the flowing is suitably performed using a flow of gas that is inert to carbon, as described elsewhere herein, and the cooling suitably occurs to a final temperature of less than about 200° C. Suitable gas flowrates can be from 0.1 to 20 sccm per gram of composition.

The method further comprises removing the flow of the inert gas. The removal of the inert gas suitably comprises bubbling the gas through a solution comprising sulfuric acid.

Adsorbates can be adsorbed using any of a variety of compositions as described herein. Suitable adsorbing methods include contacting the adsorbate-containing fluid with a carbon composition having pores, wherein the carbon composition comprises a plurality of pores, and wherein the carbon composition has a characteristic surface area of between about 1500 and 5000 m²/g, as measured according to the Brunauer-Emmet-Tellet method, and the pores of the carbon composition have a pore volume of from about 0.5 cc/g to about 4 cc/g. Without being bound to any particular theory of operation, it is believed that the particles are adsorbed into the pores of the carbon composition.

As described elsewhere herein, suitable carbon compositions having pores can be made by heating a carbon-containing inorganic precursor and reacting the precursor with one or more halogens to give rise to a porous composition comprising carbon and halogen. The porous composition is contacted with a halogen-removing agent, as described herein, to give rise to the carbon composition having pores.

The carbon composition having pores may comprise a binder. Suitable binders comprise polymers, metals, adhesives, and the like. The carbon composition may, in some instances, be formed by combining the binder with the carbon composition by blending, stirring, mixing, agitating, suspending and the like.

Contacting the composition with the adsorbate-containing fluid comprises flowing the fluid over the composition. The flowing can occur in a packed bed, a fluidized bed, and the like. The contacting may also occur by spraying the fluid into the composition followed by agitating, and also may occur by spraying the composition into the fluid followed by agitating. The adsorbate may include molecules or particles. The particles can include proteins, polymers, and the like.

Halogen species can be removed from the porous carbon composition by contacting the porous carbon composition with a suitable halogen-removing agent. The contacting suitably occurs in a furnace, as described elsewhere herein, wherein the furnace is purged, as described elsewhere herein.

The contacting also comprises flowing the halogen-removing agent over the carbon composition. Suitable agents can comprise hydrogen or ammonia. The flowing is performed for a time such that substantially all of the halogen present in the composition is no longer present. Removal of substantially all of the halogen from the porous compositions is defined such that porous compositions having substantially all halogen removed behave essentially identically to porous compositions having all halogen removed.

The agent can flow at a rate of from about 0.1 sccm per gram of porous carbon composition to about 100 sccm per gram of carbon composition. The flowing is suitably performed at a temperature of at least 200° C., at a temperature of at least 400° C.; at a temperature of at least 600° C.; at a temperature of at least 800° C.; or at a temperature of at least about 1200° C. The contacting further comprises convectively cooling the carbon composition, as described elsewhere herein.

Surface termination in porous carbon compositions can also be modified by contacting the porous carbon composition with suitable a non-halogenated surface terminating agent.

The contacting suitably occurs in a furnace, as described elsewhere herein, wherein the furnace is purged, as also described elsewhere herein.

The contacting also comprises flowing the surface-terminating agent over the carbon composition, wherein the agent can suitably comprise hydrogen or ammonia. The flowing is performed for a time such that substantially all of the halogen present in the surface terminations of the porous compositions is no longer present. Removal of substantially all of the halogen from the porous composition surface terminations is defined such that porous compositions having substantially all halogen removed from the surface terminations behave essentially identically to porous compositions having all halogen removed from the surface terminations.

The agent suitably flows at a rate from about 0.1 sccm per gram of porous carbon composition to about 100 sccm per gram of carbon composition. The flowing is suitably performed at a temperature of at least 200° C., at a temperature of at least 400° C.; at a temperature of at least 600° C.; at a temperature of at least 800° C.; or at a temperature of at least about 1200° C.

The contacting further comprises convectively cooling the carbon composition, as described elsewhere herein.

The following nonlimiting examples are provided to further illustrate the present invention.

### EXAMPLES AND OTHER ILLUSTRATIVE EMBODIMENTS

### Example 1

For the synthesis of porous carbons, selected metal carbide powder was placed onto a quartz sample holder and loaded into the hot zone of a horizontal quartz tube furnace. The quartz tube inner diameter dimension was 25 mm. The tube was Ar purged for 30 minutes at approximately 60 sccm before heating at a rate of approximately 30° C./minute up to the desired temperature. Once the desired temperature was reached and stabilized, the Ar flow was stopped and a 3-hour chlorination began with Cl₂ flowing at a rate of 20 sccm. The general reaction involved in synthesis of carbon from ternary metal carbides can be written as:

M1ₐ,M2_{b}C_{b(s)}+(c1+c2/2)C1_{2(g)}→aM1C1_{c1(g)}+bM1C1_{c2(g)}+bC₍ₛ₎,

where M1 and M2 represent carbide-forming metals. Evolved metal chlorides were trapped in a water-cooled condenser at the outlet of the heating zone. After the completion of the chlorination process, the samples were cooled down under a flow of Ar to remove residual metal chlorides from the pores, and removed for further analyses. In order to avoid a back-stream of air, the exhaust tube was connected to a bubbler filled with sulphuric acid. Carbide (Ta₂AlC and Ti₂AlC) powders obtained from 3ONE2, Inc., Voorhees, N.J., www.3one2.com, with the average particle size of approximately 15 microns; high purity chlorine (BOC Gases, 99.5%) and high purity argon (BOC Gases, 99.998%) were used.

Porosity of the produced porous carbide-derived carbons (CDC) was studied using an automated micropore gas analyzer Autosorb-1 (Quantachrome Instruments, USA). The Ar sorption isotherms collected at liquid nitrogen cryogenic temperature (−196° C.) were analyzed using Brunauer, Emmet, Teller (BET) equation and non-local density functional theory (NLDFT) to reveal the SSA and pore-size distributions of CDCs. These techniques are generally described in P. I. Ravikovitch and A. V. Neimark, Characterization of Nanoporous Materials from Adsorption and Desorption Isotherms. Colloids and Surfaces, 2001. 187-188: p. 11-21; S. Brunauer, P. Emmett, and E. Teller, Adsorption of Gases in Multimolecular Layers. J. of American Chemical Society, 1938.60: p. 309-319; S. J. Gregg and (S. W. Sing, Adsorption, Surface Area and Porosity. 1982, London: Academic Press. 42-54. S. Lowell and J. E. Schields, Powder Surface Area and Porosity. Chapman & Hall. 1998, New York. 17-29. Quantachrome Instrument's data reduction software was employed for these calculations, as generally described in Autosorb v.1.27, P. I. Ravikovitch and A. V. Neimark, Characterization of Nanoporous Materials from Adsorption and Desorption Isotherms. Colloids and Surfaces, 2001. 187-188: p. 11-21.

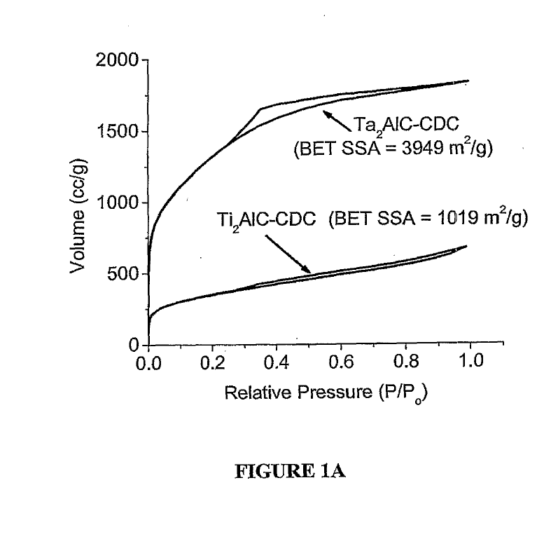

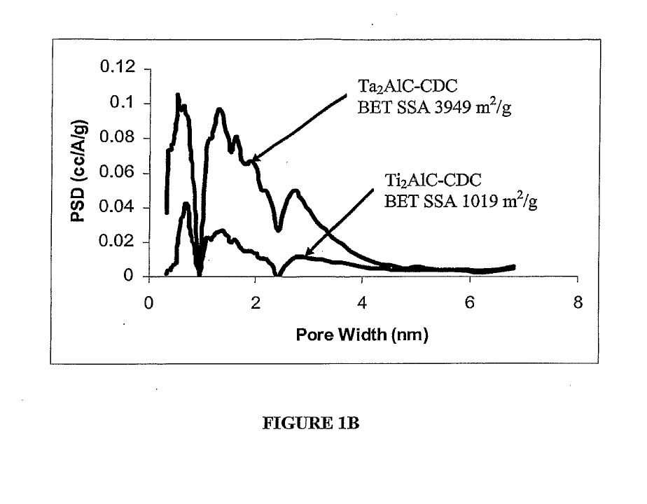

Ta₂AlC-derived carbon (Ta₂AlC-CDC) chlorinated at 800° C. yielded a BET specific surface area of approximately 4000 m²/g, while a similar carbide, Ti₂AlC-CDC synthesized at with the same conditions measured a specific surface area of only ≈1000 m² μg. FIG. 1A shows Ar sorption isotherms for both CDCs, and FIG. 1B shows the DFT pore-size distributions. The large variations in pore volume and SSA are evident. The difference between the two carbons may stem from differences in the evolved metal chlorides, metal atom size, and carbide lattice parameter.

### Example 2

Porous carbon was synthesized from Ti₃SiC₂ (average particle size=10 micron; commercially available from 30NE2, Inc., Voorhees, N.J., www.3one2.com, using the experimental setup and technique described in Example 1. Porosity analysis of the produced porous was also identical to that set forth in Example 1. H₂ annealing of porous carbon was performed using the same horizontal tube furnace setup. The flow rate of H₂ of approximately 20 sccm and annealing time of 5 hours was chosen for all experiments. The furnace tube was purged with Ar for 30 minutes at ˜60 sccm prior to heating. Sample cooling was also done under Ar flow (20 sccm).

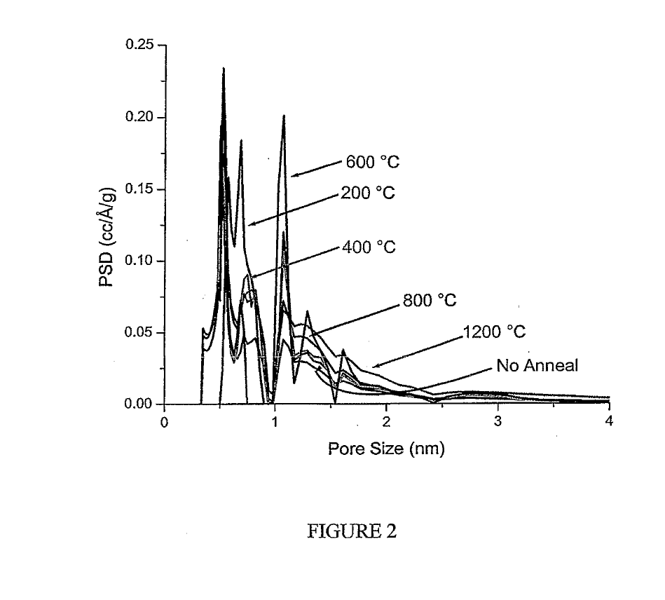

FIG. 2 and Table 1 (below) show the calculated pore-size distribution, BET SSA and pore volume for samples H₂ annealed in the 400-1200° C. temperature range. Hydrogen annealed samples showed significant increase in BET SSA. This increase in SSA at low temperature H₂ annealing is believed to be due to delicate carbon etching (from the formation of methane as a product of the reaction between carbon and hydrogen).

Table 1 indicatespore volume and BET specific surface area increasing with decreasing H₂ annealing temperature. The BET specific surface area data was calculated using multipoint BET in the range of 0.03-0.2 P/Po pressure range from Ar isotherms of FIG. 2.

TABLE 1

| | Pore Volume cc/g | BET SSA m²/g |
|---|---|---|
| No H₂ Anneal | 0.60 | 1380 |
| H₂ Anneal 1200° C. | 1.00 | 2150 |
| H₂ Anneal 800° C. | 0.84 | 1910 |
| H₂ Anneal 600° C. | 0.73 | 1750 |
| H₂ Anneal 400° C. | 0.73 | 1700 |
| H₂ Anneal 200° C. | 0.73 | 1830 |

### Example 3

For the synthesis of porous carbons, 2 grams of titanium carbide powder were placed onto a quartz sample holder and loaded into the hot zone of a horizontal quartz tube furnace. The quartz tube inner diameter was 25 mm. The tube was Ar purged for 30 minutes at ˜60 sccm before heating at a rate of ˜30° C./min up to the desired temperature (either 600 or 800° C. in these experiments).

The tube furnace's exhaust was connected to either a single bubbler filled with sulfuric acid or, optionally, to a series of two bubblers—first to a bubbler filled with sulfuric acid and then to a second bubbler filled with a solution of KOH; NaOH solution or some other solution that traps chlorine could be used in place of the KOH solution. The use of the bubbler(s) minimized the back-flow of the air and, in the case of the two-bubbler system, minimized the amount of unreacted chlorine to go to the exhaust system.

Once the desired temperature was reached and stabilized, the Ar flow was stopped and a 3-hour chlorination began with Cl₂ flowing at a rate of 20 sccm. Evolved metal chlorides were trapped in a water-cooled condenser at the outlet of the heating zone.

After the completion of the chlorination and trapping process, the samples were purged under a flow of Ar for 1 hour to remove most of the chlorine from the pores. The temperature of the furnace was then changed to the desired temperature of the treatment in ammonia. Once this desired temperature was reached, the Ar flow was stopped and ammonia was purged through the system at the rate of ˜20 sccm for either 15 or 90 min. Once the treatment was finished, samples were cooled down in a flow of Ar (˜20 sccm) and removed for further analysis.

Porosity of the produced porous carbide-derived carbons (CDC) was studied using an automated micropore gas analyzer Autosorb-1 (Quantachrome Instruments, USA). The N₂ sorption isotherms collected at liquid nitrogen cryogenic temperature (−196° C.) were analyzed using Brunauer, Emmet, Teller (BET) equation and non-local density functional theory (NLDFT) was employed for these calculations to determine the SSA and pore-size distributions of the CDCs. These procedures are generally described in S. Brunauer, P. Emmett, and E. Teller, Adsorption of Gases in Multimolecular Layers. J. of American Chemical Society, 1938, 60. p. 309-319. S. J. Gregg and K. S. W. Sing, Adsorption, Surface Area and Porosity. 1982, London: Academic Press. 42-54. S. Lowell and J. E. Schields, Powder Surface Area and Porosity. Chapman & Hall. 1998, New York. 17-29. Quantachrome Instrument's data reduction software Autosorb, v.1.27 S. Brunauer, P. Emmett, and E. Teller, Adsorption of Gases in Multimolecular Layers. J. of American Chemical Society, 1938, 60: p. 309-319.

Chemical composition of the produced samples was evaluated using energy dispersive X-ray spectroscopy (EDS). Coefficients of elemental sensitivity were used in calculations of chlorine content. The measurements were performed at 20 kV.

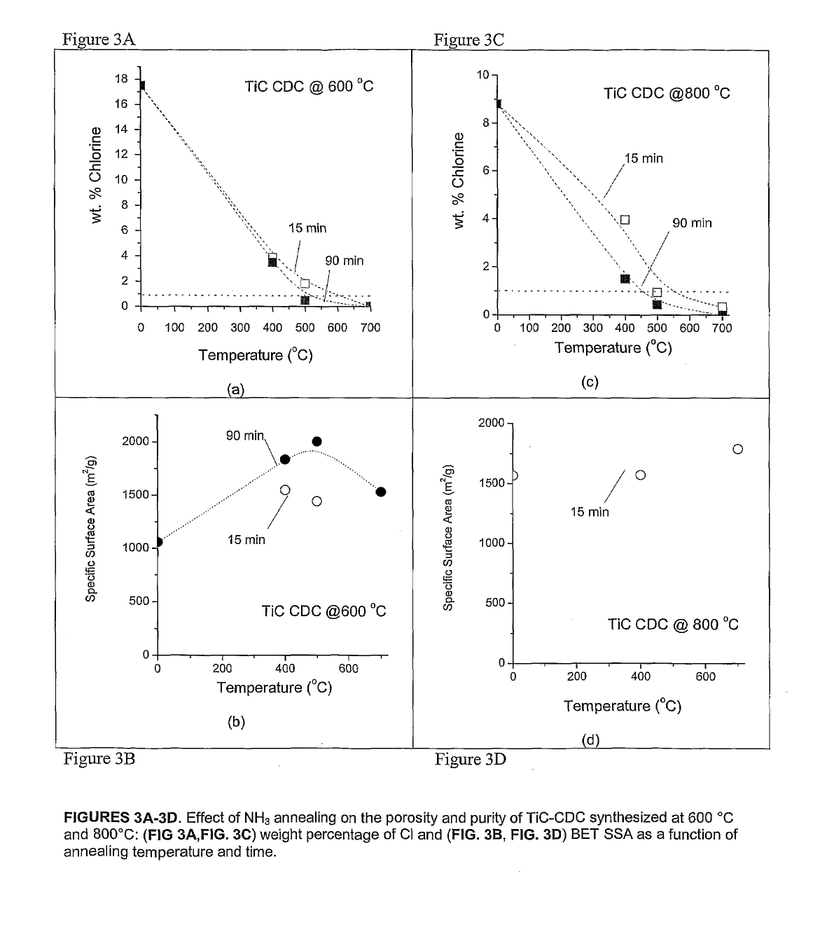

Without being bound by any particular theory of operation, the results of these examples indicate that short (15-90 minutes) treatment in ammonia at temperatures from 400-700° C. substantially increased the SSA of the samples (FIGS. 3A, 3B)—particularly the sample produced by chlorination at 600° C. (FIG. 3B). These results also indicate that the treatment process is effective in removing trapped chlorine (FIGS. 3B, 3D). Treatment in ammonia at temperatures above approximately 500° C. is generally needed to decrease the chlorine content to below 1 wt. %. Thus, low temperature of ammonia treatment (<600° C.) provides a route to purify the material and increase its pore volume without any substantial changes in the microstructure and the average pore size (changes in the average width of pores should be less than 0.5 nm).

1. A porous carbon composition, comprising:
a plurality of pores, wherein the carbon composition has a total specific surface area of between about 1500 and 5000 m2/g, as measured according to the Brunauer-Emmet-Teller method, and wherein the composition adsorbs one or more particles from a fluid.

2. The carbon composition according to claim 1, wherein the pores have a pore volume of from about 0.5 cc/g to about 4 cc/g.

3. A method for making carbon compositions having pores, comprising:
heating a carbon-containing inorganic precursor;
reacting the inorganic precursor with one or more halogens to give rise to a porous composition comprising carbon and halogen; and,
contacting the porous composition with a halogen-removing agent capable of removing the halogen to give rise to the carbon composition, wherein the carbon composition has a characteristic surface area of between about 1500 m2/g and 5000 m2/g, as measured according to the Brunauer-Emmet-Tellet method, and wherein the pores have a pore volume of from about 0.5 cc/g to about 4 cc/g.

4. The method according to claim 3 wherein the carbon-containing inorganic precursor comprises carbide.

5. The method according to claim 4, wherein the carbide comprises ternary carbide or carbonitride.

6. The method according to claim 5, wherein the ternary carbide comprises a MAX-phase group layered carbide.

7. The method according to claim 3 wherein the carbon-containing inorganic precursor is convectively heated.

8. (canceled)

9. (canceled)

10. (canceled)

11. (canceled)

12. The method according to claim 3, wherein the heating occurs to a temperature of at least about 400° C.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. A method of adsorbing an adsorbate from a fluid, comprising:
contacting a fluid comprising an adsorbate with a carbon composition, wherein the carbon composition comprises a plurality of pores, and wherein the carbon composition has a characteristic surface area of between about 1500 and 5000 m2/g, as measured according to the Brunauer-Emmet-Tellet method, and the pores of the carbon composition have a pore volume of from about 0.5 cc/g to about 4 cc/g.

57. The method of claim 56, wherein the carbon composition is made by heating a carbon-containing inorganic precursor; reacting the precursor with one or more halogens to give rise to a porous composition comprising carbon and halogen, and contacting the porous composition with a species capable of removing halogen to give rise to the carbon composition.

58. (canceled)

59. (canceled)

60. (canceled)

61. (canceled)

62. (canceled)

63. (canceled)

64. (canceled)

65. (canceled)

66. The method of claim 56, wherein the adsorbate comprises molecules.

67. The method of claim 56, wherein the adsorbate comprises particles.

68. (canceled)

69. A method for removing halogen species present in a porous carbon composition, comprising:
providing a composition comprising a plurality of pores, and wherein the carbon composition has a total specific surface area of between about 1500 and 5000 m2/g, as measured according to the Brunauer-Emmet-Teller method, and wherein the pores have a pore volume of from 0.5 to 4 cc/g; and,
contacting the porous carbon composition with a halogen-removing agent.

70. (canceled)

71. The method according to claim 70, wherein the agent includes hydrogen or ammonia.

72. The method according to claim 71, wherein the contacting is performed for a time such that substantially all of the halogen present in the composition is no longer present.

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. A method for modifying surface termination in a porous carbon composition, wherein the composition comprises a plurality of pores, and wherein the carbon composition has a total specific surface area of less than about 5000 m2/g, as measured according to the Brunauer-Emmet-Teller method; and,
contacting the porous carbon composition with a non-halogenated surface terminating agent.

85. (canceled)

86. (canceled)

87. The method according to claim 86, wherein the contacting is performed for a time such that substantially all of the halogen present in the surface terminations of the composition is no longer present.

88. The method according to claim 87, wherein removal of substantially all of the halogen from the surface terminations of the composition is defined such that compositions having substantially all halogen removed from the surface terminations behave essentially identically to compositions having all halogen removed from the surface terminations.

89. (canceled)

90. (canceled)

91. (canceled)

92. (canceled)

93. (canceled)

94. (canceled)

95. (canceled)

96. (canceled)

97. (canceled)

98. (canceled)

99. A modified porous carbon composition made according to the process of claim 84.
